(19) United States
(12) Patent Application Publication
(10) Pub. No.: US 2016/0012497 A1
(43) Pub. Date: Jan. 14, 2016

(54) AUTOMATED DETERMINATION OF RETURN ENVELOPE OMISSION OR INCLUSION

(71) Applicant: Shannon Stafford, Clyde Hill, WA (US)

(72) Inventor: Shannon Stafford, Clyde Hill, WA (US)

(21) Appl. No.: 14/642,172

(22) Filed: Mar. 9, 2015

Related U.S. Application Data
(63) Continuation of application No. 14/249,093, filed on Apr. 9, 2014, now abandoned.

(51) Int. Cl. G06Q 30/04

(52) U.S. Cl. CPC G06Q 30/04

(57) ABSTRACT

A mailing service maintains a database of customers that receive periodic billing statements, such as from a vendor or vendors that operate or are associated with the mailing service. The mailing service may initiate sending a printed copy of a billing statement to a customer, and include with that billing statement a remittance mechanism that is provided for the customer's use in providing a monetary payment related to the billing statement. Based on receiving a communication related to the customer and/or the billing statement, the mailing service may automatically determine to send future printed billing statements to the customer without including a remittance mechanism for the customer's use, and based on such determination may thereafter initiate sending additional printed billing statements to the customer without including a remittance mechanism.

### BACKGROUND

1. Technical Field

The present disclosure relates to an improved Mailing Service system and, in particular, to methods, systems, and apparatuses for enabling automatic determinations as to whether to include or omit a return envelope as part of printed mailings to particular customers.

2. Description of the Related Art

As the Internet and other online access to information and services continue to grow, users are increasingly presented with opportunities to eschew printed materials in favor of such electronic information and services. One particular example of such opportunities involves electronic billing and payment systems, which allow customers to receive electronic notifications of amounts owed to various vendors and services, and to electronically provide payments to those vendors and services, such as via the World Wide Web (“the Web”). In certain situations, however, certain users may find it beneficial to receive printed notifications or billing statements from a vendor or service (such as for recordkeeping or other purposes) even if those users wish to make payments or other remittances associated with those printed materials electronically rather than via return mail.

### SUMMARY

In certain embodiments, a mailing service may maintain a database of customers that receive periodic billing statements, such as from a vendor or vendors that operate or are associated with the mailing service. In other embodiments, the mailing service may be operated by or associated with a banking service associated with such vendors, or another type of entity altogether, such as any entity that may have occasion to use return envelopes in printed mailings to the customers for those customers' use in returning payment or other remittances to the mailing service or other entity.

In certain embodiments, the mailing service may initiate sending a printed copy of the billing statement to a customer, and include with that billing statement a return envelope that is provided for the customer's use in providing a monetary payment related to the billing statement. Thereafter, the mailing service may receive a communication related to the customer and, based at least in part on that received communication, automatically determine to send future printed billing statements to the customer without including a return envelope for the customer's use. Based on such automatic determination, the mailing service may initiate sending additional printed billing statements to the customer without a return envelope.

In other embodiments, the mailing service or vendor may provide the customer with access to account balance information electronically, such that the customer may pay their account balance before receiving a printed copy of their billing statement. The payment may be electronic, in person, or by mail. The mailing service may automatically determine, based on a payment by the customer, that no return envelope is to be included with the printed copy of the billing statement.

### BRIEF DESCRIPTION OF THE DRAWINGS

For a better understanding of the present disclosure, preferred embodiments thereof are now described purely by way of non-limiting example and with reference to the attached drawings, wherein:

FIG. 1 is a network diagram illustrating an example embodiment of interactions related to a Mailing Service system in accordance with the techniques described herein.

FIG. 2 is a block diagram illustrating an embodiment of a computing system suitable for providing a Mailing Service system in accordance with techniques described herein.

FIGS. 3A-3B depict a flow diagram of an example embodiment of a Mailing Service Manager routine.

### DETAILED DESCRIPTION

The present disclosure is generally directed to techniques for performing automated determinations with respect to the inclusion or exclusion of return envelopes (or other remittance mechanisms) from printed materials for distribution to customers. Some or all of the techniques described herein may be performed by automated operations of an embodiment of a Mailing Service system, as discussed in greater detail below.

As used herein, a “customer” may include any individual or entity capable of receiving printed materials via physical delivery. A “user” may include individual users of a computing system or any other entity interacting with the computing system on behalf of an individual user, including past, future or current users, and may also be used interchangeably with “customer,” regardless of whether the referenced customer is interacting or has interacted with any such computing system. Reference herein to a “user” or “customer” without further designation may include a single person, or in some situations a group of affiliated persons, and may, depending on the context in which the term is used, refer to single or multiple entities.

Also as used herein, the term “vendor” may include any entity requesting payment or other remittance from a customer on behalf of that entity. For example, a vendor may be a merchant regularly or irregularly engaged in the sale or other transfer of products or services in exchange for a monetary payment or other remuneration; a charitable, political, or other organization engaged in solicitation of monetary payment or other remuneration on behalf of the organization or other parties; etc. Reference herein to a “vendor” without further designation may include a single entity or multiple entities.

Also as used herein, the term “billing statement” may include any communication intended to convey a request for monetary payment or other remuneration, and while such requests may be based on past, present, or future transfers of products and/or services, such requests may also be based on solicitations for donations or other unilateral payments that occur without such transfer. A billing statement, as used herein, may or may not include an indication of a specific balance requested for payment by the vendor on behalf of whom such request is made. For example, a billing statement from a retail merchant vendor may include a particular account balance accrued by the customer receiving the billing statement, such as if the customer acquired various goods and services from the retail merchant during a particular billing period. However, a billing statement from a political organization soliciting campaign contributions for a political candidate or other purpose, or from a charitable organization soliciting donations, may not include an account balance, allowing the customer to determine some particular payment amount to provide to the vendor organization. Similarly, as used herein the term “remittance mechanism” may refer to a return envelope, physical payment coupon, designated portion of a printed billing statement, or any combination thereof.

In certain embodiments, the described techniques include computer-implemented methods performed by one or more computing systems that are configured to provide a Mailing Service system. For example, the Mailing Service system may initiate the electronic or physical preparation and transmission of billing statements to customers, such as based on information stored by the Mailing Service system and/or information provided by a service and/or vendor associated with the Mailing Service system. Similarly, in certain embodiments the Mailing Service system may receive communications, payments, and/or indications of such communications and payments from customers, such as customers that may or may not have previously received a billing statement from the Mailing Service system. Based at least in part on such communications and/or payments from a particular customer, the Mailing Service system may in at least some embodiments automatically determine whether to include or omit a remittance mechanism from future billing statements physically provided to that customer.

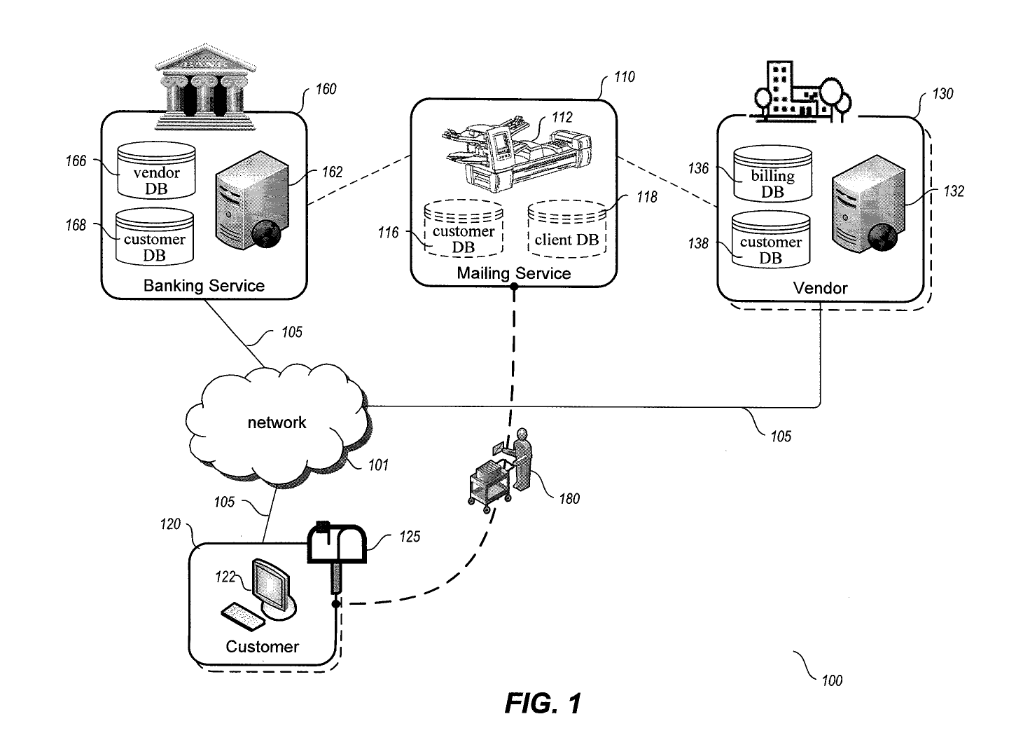

FIG. 1 is a schematic diagram of a networked environment 100 that includes a Mailing Service system 110 as well as various entities communicatively coupled to and/or interacting with the Mailing Service system, including customers 120, vendors 130, and a banking service 160. With respect to at least some embodiments discussed below, the discussion may refer to aggregating types of information associated with some or all of the customers, vendors, and other communicative entities, but it will be appreciated that the same or similar techniques may be applied to other types of information and for other types of uses in other embodiments. In various embodiments, the Mailing Service system 110 may be operated by and/or otherwise associated with one or more of the vendors 130, may be operated by and/or otherwise associated with the banking service 160, or may be operated independently by a third-party entity, such as in order to provide a third-party mail service for vendors 130, banking service 160, or both.

The illustrated example of FIG. 1 includes a number of customers 120 that are each interacting at various times with the Mailing Service system 110, such as by physical interactions using customer mailbox 125 and a delivery service 180 (e.g., the United States Postal Service or other mail carrier), or by electronic interactions performed via customer computing system 122 and one or more networks 101. For example, a customer 120 may, after physically receiving a printed billing statement (not shown) from a vendor 130 via the Mailing Service, elect to provide a payment to the sender of the billing statement either physically or electronically. To pay the account balance physically, the customer typically includes a check or other payment instrument (such as a payment card number) with a remittance mechanism provided as part of the printed billing statement, and physically transmits the remittance mechanism to a mailing address indicated by the remittance mechanism itself. Alternatively, the customer may elect to provide a payment electronically via interactions with a Web site or other electronic exchange indicated by the billing statement and associated with the relevant vendor or banking service.

As a first example described with reference to the illustrated embodiment of FIG. 1, consider Mailing Service system 110 operated by or as part of a vendor 130. The vendor 130 maintains a Web server 132, a billing information database 136, and a customer information database 138, and is communicatively coupled to network 101 via a communication link 105. Possibly as a result of various transactions with customer 120, either or both of the vendor's billing information database and customer information database contain information related to the customer, including a current account balance indicating a monetary amount owed the vendor 130 by the customer 120. At some time, possibly but not necessarily as part of a periodic billing cycle, the vendor initiates the preparation of a billing statement indicating the customer's current account balance and transmittal of that billing statement to the customer. In certain embodiments, as a result of such initiating, the Mailing Service system 110 retrieves information associated with the customer from the vendor databases 136 and/or 138 in order to prepare the customer billing statement; in other embodiments, the Mailing Service may maintain a separate customer information database 116 containing information associated with the customer necessary to prepare and transmit a billing statement to the customer.

In at least some embodiments, the Mailing Service system 110 analyzes the relevant customer information (such as customer preference information, physical address information and/or electronic address information, etc.) to determine whether the billing statement should be prepared and transmitted to the customer physically or electronically. In this example, such information indicates that the billing statement is to be prepared and transmitted physically to the customer. Based on such information, therefore, the Mailing Service system 110 utilizes mailing preparation devices 112 to prepare a printed billing statement for the customer.

In certain embodiments, the Mailing Service system 110 automatically determines whether, as part of preparing the customer billing statement, the customer billing statement should include a remittance mechanism for the customer's use in providing payment to the vendor 130 in a physical manner. For example, in an embodiment of the customer information database 138 (or, alternatively, the customer information database 116) includes information indicative of a payment history for the customer, such as if the customer has provided electronic payment to satisfy one or more previous billing statements. In such embodiments, the Mailing Service system 110 may determine whether to include a remittance mechanism as part of the printed billing statement based at least in part on one or more predefined criteria, such as based on various criteria associated with a payment history of the customer. A non-exhaustive list of such criteria may include: whether the customer has provided a predefined quantity of electronic payments, such as may meet or exceed a threshold quantity of consecutive electronic payments or a threshold quantity of electronic payments during a particular period of time; whether the customer has provided a predefined quantity of physical payments, such as may meet or exceed a threshold quantity of consecutive physical payments or a threshold quantity of physical payments during a particular period of time; whether the customer's most recent payment or payments have been made in a particular manner; etc. In various embodiments, therefore, various actions by the customer may be utilized by the Mailing Service system 110 as implicit indications that remittance mechanisms are to be included in or omitted from billing statements physically transmitted to that particular customer.

In certain embodiments, the Mailing Service system 110 may determine whether to include a remittance mechanism as part of the printed billing statement based on one or more explicit indications from the customer, such as may have been transmitted to the Mailing Service system 110 or the vendor 130 by the customer in various manners. For example, in an embodiment a remittance mechanism provided as part of an earlier printed billing statement from the Mailing Service system 110 (and returned by the customer to the Mailing Service or vendor) may indicate one or more options for the customer related to future billing statements, including options allowing the customer to specify a preference for printed or electronic billing statements, and/or an option allowing the customer to specify that remittance mechanisms should be omitted from future printed billing statements sent to the customer (such as if the customer plans to provide future payments electronically). In at least some embodiments, such options may be provided to the customer via one or more Web sites, such as options included in a graphical user interface provided by Web server 132. In such embodiments, the customer may interact with the graphical user interface in a variety of ways to indicate preferences related to the preparation and transmission of future billing statements. In addition, in certain embodiments the customer may have expressed a preference related to future billing statements by interacting with a human representative of the banking service 160—such as by telephone, printed or electronic mail, or personal interaction—and the representative may update a profile of the customer (as stored in customer information database 168 or elsewhere) accordingly.

Once the mailing system 110 has determined whether to include or omit a remittance mechanism as part of the printed billing statement, the mailing system utilizes mailing preparation devices 112 to prepare the printed billing statement for transmission. The mailing preparation devices 112 may comprise a single or multiple devices and, in various embodiments, perform functionality similar to that of one or more of an office printer, an offset printing press, a mail merge module, an envelope supply receptacle, an envelope assembly mechanism, a paper folding mechanism, a paper and/or envelope insertion mechanism, etc. Once the printed billing statement has been prepared, such as part of an assembled mailing envelope, the mailing system 110 may initiate providing of the printed billing statement and/or assembled mailing envelope to the delivery service 180 for delivery to the customer 120, such as via a customer mailbox 125 that is associated with a physical mailing address of the customer.

As a second example described with reference to the illustrated embodiment of FIG. 1, consider Mailing Service system 110 operated as part of banking service 160. In certain embodiments, the banking service 160 may to some extent operate as a vendor with respect to the functionality described above in the first example described with reference to FIG. 1 such as if the customer owes one or more monetary payments to the banking service (e.g., if the customer utilizes a credit card issued by or otherwise drawn upon the banking service). In such embodiments, the banking service may issue billing statements to the customer on its own behalf as a vendor, in a manner similar to that described above. However, for purposes of this example, it is assumed that banking service 160 utilizes Mailing Service system 110 to provide billing statements on behalf of one or more vendors 130. The banking service maintains a Web server 162, a vendor information database 166, and a customer information database 168, and is communicatively coupled to network 101 via a communication link 105. Vendor information database 166 may include, for example, billing information provided to the banking service by one or more of the vendors 130, such as accounts receivable information or other information indicating particular monetary amounts owed the vendor by one or more parties that include the customer 120. Customer information database 168 may include, for example, customer address and/or other contact information as well as customer preference information.

At some time, in a manner similar to that described above with respect to the Mailing Service system 110 operated as part of vendor 130, the banking service 160 initiates the preparation and transmittal of a billing statement to the customer. In various embodiments, the printed billing statement may be associated with a single vendor or with multiple vendors, and may include information (such as an account balance) related to a respective account of the customer 120 for each of the single or multiple vendors, either individually or collectively. The Mailing Service system 110 retrieves information associated with the customer from the customer information database 168 (or, if separately maintained by the Mailing Service system 110, customer information database 116) in order to prepare the customer billing statement.

In a manner similar to that described above, the Mailing Service system 110 analyzes the relevant customer information to determine whether the billing statement should be prepared and transmitted to the customer physically or electronically. In this example, such information indicates that the billing statement is to be prepared and transmitted physically to the customer. Once again, the Mailing Service system 110 utilizes mailing preparation devices 112 to prepare a printed billing statement for the customer. Furthermore, in a manner similar to that described above, the Mailing Service system 110 performs an automated determination as to whether to include or omit a remittance mechanism for the customer's use in providing a physical payment. Such determination may be based on implicit and/or explicit indications from the customer. Moreover, the Mailing Service system 110 may determine to include or omit a remittance mechanism based on a payment history associated with the customer, whether that payment history includes payments made to the vendor(s) associated with the printed billing statement, payments made to other vendors not associated with the printed billing statement, or both. For example, the Mailing Service system may determine, based on one or more electronic payments made via the banking service to Vendor A, to omit a remittance mechanism such as a return envelope from a billing statement associated with Vendor B. Similarly, in certain embodiments the Mailing Service system may determine to include a return envelope with a billing statement associated with Vendor A based on physical payments furnished to Vendor B, despite one or more electronic payments the customer has provided to Vendor A (such as if the customer has provided a physical payment to Vendor B more recently than the electronic payments to Vendor A, or for other reasons). In other embodiments, the Mailing Service system may make the determination to include or omit a remittance mechanism with the printed billing statement on a per-vendor basis—e.g., limiting the basis of such determination to a customer's payment history with a single particular vendor.

As one example with continuing reference to FIG. 1, suppose that a vendor 130 operates the Mailing Service as part of its own operations, and uses the Mailing Service system 110 to prepare and distribute printed billing statements to its customers. In May, the Mailing Service system utilizes the delivery service 180 and information from the vendor's billing database 136 and customer database 138 to prepare and send a printed billing statement to Jane (one of the customers 120 of FIG. 1) related to Jane's May account balance with the vendor 130. Based on the information related to Jane contained in one or both of the billing and customer databases, the Mailing Service system determines to include a return envelope as part of the printed billing statement, so that Jane may use the return envelope to provide physical payment for her account balance to the vendor 130.

Although the printed billing statement includes a return envelope for her use, Jane decides to pay her May account balance electronically. She logs in to the vendor's Web site (such as by using her computing system 122 and a graphical user interface provided by the vendor's Web server 132). Using her credit card (not shown), Jane authorizes an electronic payment of some or all of her May account balance with the vendor. Responsive to the electronic payment, the Web server 132 sends information updating Jane's records in one or both of the vendor's billing database 136 and customer database 138. The updated information includes Jane's new account balance, reflecting the May payment, and an indication that the May payment was provided electronically.

Continuing the example above, in June the vendor 130 again uses the Mailing Service system 110 to prepare and distribute printed billing statements to its customers, and the Mailing Service system again uses the delivery service 180 and information from the vendor's billing database 136 and customer database 138 to prepare and send a printed billing statement to Jane related to Jane's account balance with the vendor 130. However, because of the updated information in the vendor's customer and/or billing databases, and in particular the indication of Jane's electronic payment during the previous month, the Mailing Service determines that Jane likely prefers paying electronically, and therefore also determines to omit a return envelope from Jane's printed billing statement for June.

In certain embodiments, if it is determined by the Mailing Service system that a remittance mechanism is to be included with or as part of the printed billing statement, a separate respective remittance mechanism may be included for each vendor associated with the billing statement. For example, if the billing statement indicates that the customer owes a distinct account balance to each of three distinct vendors listed therein, the fully assembled billing statement may include a separate return envelope for each of the three distinct vendors, each with a separate and distinct return address for remittance of a respective payment. In other embodiments, a single remittance mechanism may be included with the printed billing statement regardless of how many vendors are associated with the billing statement, such that the customer may provide a single payment to the banking service 160 for appropriate disbursement to the associated vendors.

In at least some embodiments, the Mailing Service system 110 may determine whether to include a remittance mechanism as part of a printed billing statement based on one or more explicit indications from the customer to the banking service 160. Such explicit indications may be provided as a selection by the customer of options related to future billing statements, such as may be included in a remittance mechanism previously provided to the customer; provided via one or more interactions of the customer with a graphical user interface provided by Web server 162; provided via one or more interactions of the customer with a human representative of the banking service 160; etc.

Once the mailing system 110 has determined whether to include or omit a remittance mechanism as part of the printed billing statement, the mailing system utilizes mailing preparation devices 112 to prepare the printed billing statement for transmission and may initiate providing of the printed billing statement to delivery service 180 for delivery to the customer 120.

As a third example described with reference to the illustrated embodiment of FIG. 1, in certain embodiments Mailing Service system 110 may be operated independently from vendors 130 or banking service 160, such as by a third party (not shown). In such embodiments, the Mailing Service system 110 may provide billing statements on behalf of the vendors 130, including on behalf of banking service 160 to the extent that the banking service operates as a vendor. In such embodiments, the Mailing Service system may perform one or more determinations as to whether to include or omit remittance mechanisms with printed billing statements sent to one or more customers 120 based on payment history and/or customer preference information provided to the Mailing Service system by one or more of the vendors 130 and banking service 160. Such preference information may be obtained by the vendors and/or banking service in various manners described above, including options presented to and selected by a customer via previous remittance mechanisms, electronic interactions with electronic or other interfaces provided by such entities, interactions with human representatives, etc.

The interactions of entities with the Mailing Service system may occur in various ways, such as in an interactive manner or in programmatic manner via one or more software applications via an Application Program Interface (“API”) provided by the Mailing Service system 110 that allows computing systems and/or programs to invoke such functionality programmatically, such as using Web services or other network communication protocols. In certain embodiments, vendors, banking services, or other service providers may integrate various functionality of the Mailing Service system into their own provided services in such a programmatic manner, such as programmatically adding or updating customer information, billing information, or other information.

Similarly, interactions between the Mailing Service system and computing systems associated with the vendors 130 and/or the banking service 160 may be performed manually, programmatically, or in some other fashion. In the illustrated embodiment, various interactions between users 120 and any or all of the Mailing Service system 110, vendors 130 and/or banking service 160 may be performed using any or all of a web browser, a client application or “app” (such as may be associated with or provided by an operator of the Mailing Service system 110), or a mobile application (which may similarly be associated with or provided by an operator of the Mailing Service system) executing on a mobile device of the user (not shown). The web browser may be executing on a fixed or mobile computing device associated with or otherwise available to the user, such as customer computing system 122.

In situations in which the Mailing Service system 110 or a service provider provide one or more Web sites, at least some users 120 may perform various interactions at such Web sites. For example, a user may use a client computing device (not shown) to interact with the Mailing Service system 110 over the network 101, such as to obtain Web pages or other electronic information pages (e.g., HTML-based emails, or other groups of information that are formatted at least in part based on HTML or other formats or markups) from the Mailing Service system, and to optionally provide various information. Such users 120 may access a Web site provided by the Mailing Service system or associated entity to obtain one or more Web pages. In certain embodiments, the Mailing Service system may store various types of user information about such online interactions, including in some cases to record and store information about all interactions and activities performed by the user with respect to the Mailing Service system.

In the illustration of FIG. 1, the network 101 may include a publicly accessible network of linked networks, possibly operated by various distinct parties, such as the Internet, although in other embodiments the network 101 may have other forms. For example, the network 101 may instead be a private network, such as, a corporate or university network that is wholly or partially inaccessible to non-privileged users. In still other embodiments, the network 101 may include both private and public networks, with one or more of the private networks having access to and/or from one or more of the public networks. Furthermore, the network 101 may include various types of wired and/or wireless networks in various situations. In addition, in this illustrated example of FIG. 1, the users 120, the vendors 130, and the banking service 160 may use various client computing systems to interact with the Mailing Service system 110 to obtain various described functionality via the network 101, and in doing so may provide various types of information to the Mailing Service system 110. Moreover, in certain embodiments, the various users and providers of the networked environment 100 may interact with the Mailing Service system and/or one or more other users and providers using an optional private or dedicated connection, such as one or more VPN (Virtual Private Network) connections.

It will be appreciated that various of the details illustrated with respect to FIG. 1 are provided for illustrative purposes, and may be different in other embodiments. For example, the Mailing Service system 110 may obtain and store other types of information (whether by storing additional types of information, and/or by not storing at least some of the illustrated types of information), and the information may be stored in various manners (e.g., in a multi-tenant data warehouse or other database, in one or more remote storage devices operated by entities directly associated with the Mailing Service system 110 or other third-party entities, in multiple distinct databases that are each specific to a type of data and/or to a particular vendor, etc.), including to be grouped in other manners than is illustrated. Similarly, the Mailing Service system 110 may provide other types of functionality than those described (whether by providing additional types of functionality, and/or by not providing at least some of the described types of functionality), and the functionality may be provided via various types of interfaces.

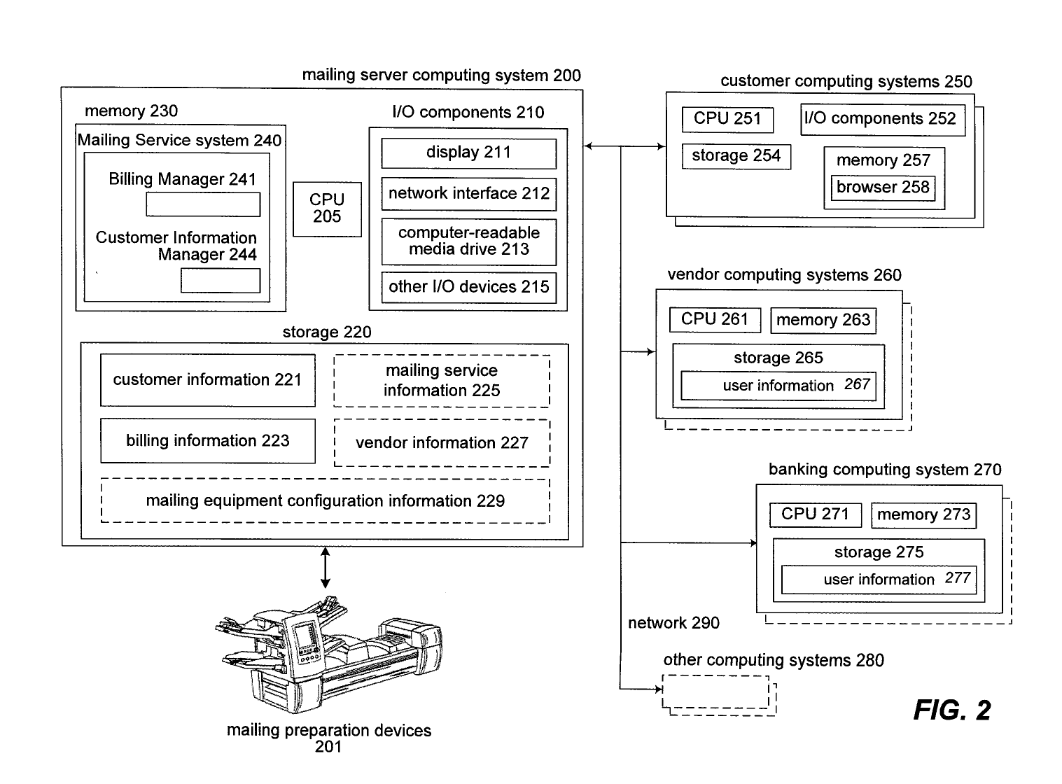

FIG. 2 is a block diagram illustrating an embodiment of a mailing server computing system 200 that is suitable for performing at least some of the described techniques, such as by executing an embodiment of a Mailing Service system. The computing system 200 includes one or more central processing units (“CPU”) or other processors 205, various input/output (“I/O”) components 210, storage 220, and memory 230, with the illustrated I/O components including a display 211, a network interface 212, a computer-readable media drive 213, and other I/O devices 215 (e.g., keyboards, mice or other pointing devices, microphones, speakers, GPS receivers, etc.). The mailing server computing system 200 and Mailing Service system 240 may communicate with other computing systems via one or more networks 290 (e.g., the Internet, one or more cellular telephone networks, etc.), such as customer computing systems 250, vendor computing systems 260, banking computing system 270, and other computing systems 280. Some or all of the computing systems may similarly include some or all of the types of components illustrated for server computing system 200 (e.g., to have a Mailing Service system client application (not shown) executing in memory 263 of a vendor computing system 260 in a manner analogous to Mailing Service system 240 executing in memory 230). In the illustrated embodiment, the mailing server computing system is communicatively coupled to mailing preparation devices 201, which may perform functionality similar to that described elsewhere herein with respect to mailing preparation devices 112 of FIG. 1.

In the illustrated embodiment, an embodiment of the Mailing Service system 240 executes in memory 230 in order to perform at least some of the described techniques, such as by using the processor(s) 205 to execute software instructions of the system 240 in a manner that configures the processor(s) 205 and computing system 200 to perform automated operations that implement those described techniques. As part of such automated operations, the Mailing Service system 240 executing in memory 230 may store and/or retrieve various types of data, including in the example database data structures of storage 220. In this example, the data used may include various types of customer information in database (“DB”) 221, various types of billing information in DB 223, and (optionally) various types of delivery service information in DB 225, various types of vendor information in DB 227, and/or various types of mailing preparation device or mailing equipment configuration information in DB 229.

It will be appreciated that mailing server computing system 200 and computing systems 250, 260, 270 and 280 are merely illustrative and are not intended to limit the scope of the present invention. The systems and/or devices may instead each include multiple interacting computing systems or devices, and may be connected to other devices that are not specifically illustrated, including through one or more networks such as the Internet, via the Web, or via private networks (e.g., mobile communication networks, etc.). More generally, a device or other computing system may comprise any combination of hardware that may interact and perform the described types of functionality, optionally when programmed or otherwise configured with particular software instructions and/or data structures, including without limitation desktop or other computers (e.g., tablets, slates, etc.), database servers, network storage devices and other network devices, smart phones and other cell phones, consumer electronics, digital music player devices, handheld gaming devices, PDAs, wireless phones, pagers, electronic organizers, Internet appliances, television-based systems (e.g., using set-top boxes and/or personal/digital video recorders), and various other consumer products that include appropriate communication capabilities. In addition, the functionality provided by the illustrated Mailing Service system 240 may in some embodiments be distributed in various modules other than those specific modules depicted. Similarly, in some embodiments, some of the functionality of the Mailing Service system 240 may not be provided and/or other additional functionality may be available.

It will also be appreciated that, while various items are illustrated as being stored in memory or on storage while being used, these items or portions of them may be transferred between memory and other storage devices for purposes of memory management and data integrity. Alternatively, in other embodiments some or all of the software modules and/or systems may execute in memory on another device and communicate with the illustrated computing systems via inter-computer communication. Thus, in some embodiments, some or all of the described techniques may be performed by hardware means that include one or more processors and/or memory and/or storage when configured by one or more software programs (e.g., the Mailing Service system 240 and/or Mailing Service client software executing on any or all of computing systems 250, 260, 270 and 280) and/or data structures, such as by execution of software instructions of the one or more software programs and/or by storage of such software instructions and/or data structures. Furthermore, in some embodiments, some or all of the systems and/or modules may be implemented or provided in other manners, such as by consisting of one or more means that are implemented at least partially in firmware and/or hardware (e.g., rather than as a means implemented in whole or in part by software instructions that configure a particular CPU or other processor), including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a non-transitory computer-readable storage medium, such as a hard disk or flash drive or other non-volatile storage device, volatile or non-volatile memory (e.g., RAM or flash RAM), a network storage device, or a portable media article (e.g., a DVD disk, a CD disk, an optical disk, a flash memory device, etc.) to be read by an appropriate drive or via an appropriate connection. The systems, modules and data structures may also in some embodiments be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of the present disclosure may be practiced with other computer system configurations.

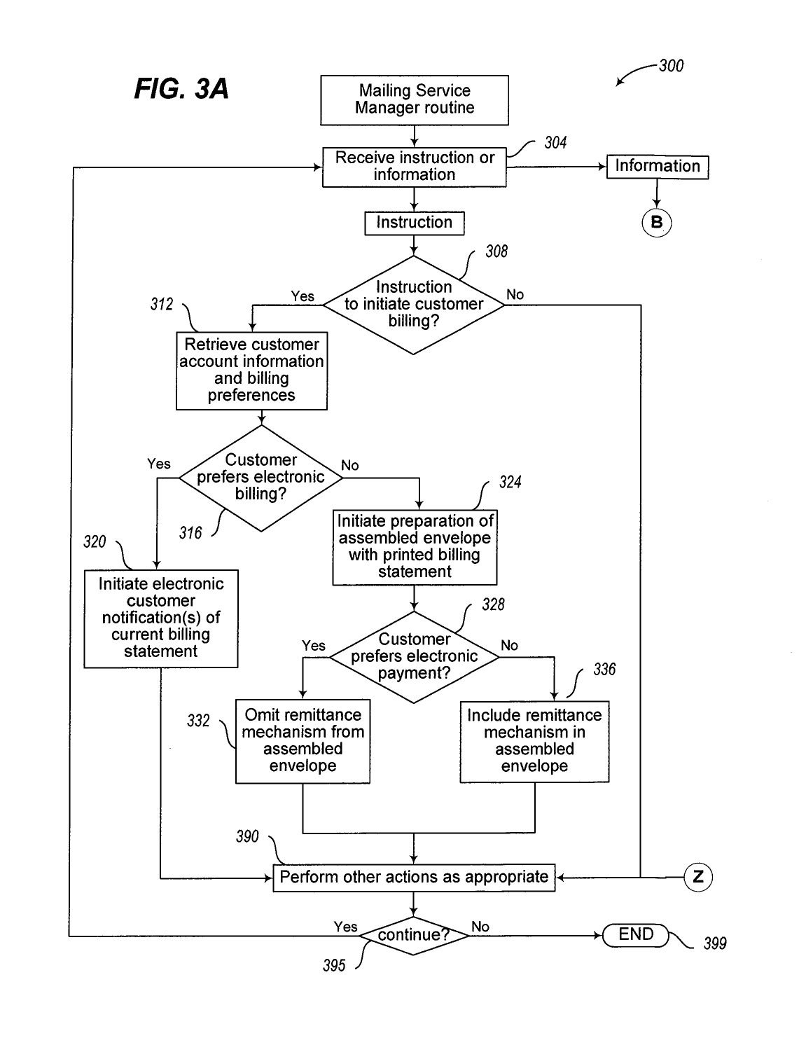

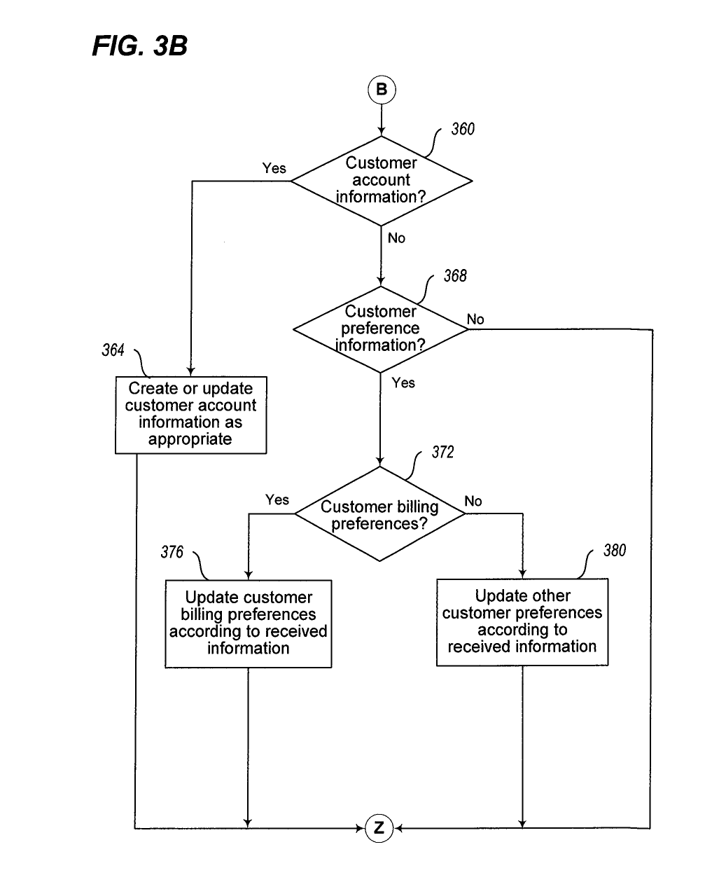

FIG. 3 is a flow diagram of an example embodiment of a Mailing Service Manager routine 300, such as may be performed by one or more modules of the Mailing Service system 110 of the networked environment 100 depicted by FIG. 1, and/or the Mailing Service system 240 executed by the mailing server computing system 200 of FIG. 2. The routine begins at block 304, in which the routine receives an indication of an instruction or information. If the routine has received an instruction, it proceeds to block 308 to determine whether the indicated instruction is to initiate a billing process for a customer. If so, the routine proceeds to block 312 and retrieves the relevant customer account information, including any customer preferences related to billing statements for that customer. The routine then proceeds to block 316 to determine, based on the retrieved customer billing preferences, whether the customer prefers electronic billing or prefers to receive printed billing statements via a physical delivery service.

If it is determined in block 316 that the customer prefers electronic billing, the routine proceeds to block 320, and initiates one or more electronic notifications to the customer related to a current billing statement for the customer. Such notifications may include, for example, one or more of an electronic mail message, text message, automated telephone call, etc. Alternatively, if it is determined in block 316 that the customer prefers to receive printed billing statements, the routine proceeds to block 324 to initiate preparation of an assembled envelope with a printed billing statement, and then to block 328 to determine whether the customer is likely to prefer providing electronic payment to satisfy the current billing statement. If it is determined in block 328 that the customer is likely to prefer providing electronic payment, the routine proceeds to block 332, and completes the preparation of the assembled envelope without including a remittance mechanism for the customer's use. If it is determined in block 328 that the customer is likely to prefer providing payment associated with the printed billing statement in a physical manner, the routine proceeds to block 336 and includes a remittance mechanism in the assembled envelope.

If it was determined in block 304 that the routine has received information rather than an instruction, the routine proceeds to block 360 (with reference to FIG. 3B), and determines whether the received information comprises customer account information, such as new or updated contact information, account balance information, or transaction history information for the customer. If so, the routine proceeds to block 364, and creates or updates account information for the customer as appropriate. If it is determined in block 360 that the received information is not customer account information, the routine proceeds to block 368 to determine whether the received information comprises customer preference information. If so, the routine proceeds to block 372 to determine whether the received information indicates one or more customer billing preferences. For example, the received information may include implicit or explicit indications of customer preferences, such as updated information related to a payment history of the customer, or information indicative of customer selections of one or more options with respect to future billing statements. If it is determined that the received information is indicative of one or more customer billing preferences, the routine proceeds to block 376 to update billing preferences for the customer according to the received information. In certain embodiments, for example, the routine may determine to update one or more data fields related to future billing statements for the customer (such as to indicate that future printed billing statements for the customer should omit or include a remittance mechanism) based on updated payment history information received for the customer. Alternatively, if it is determined in block 372 that the received information does not include information indicative of customer billing preferences, the routine proceeds to block 380 to update other customer preferences according to the received information.

After blocks 320, 332, 336, 364, 376, or 380, or if it was determined in block 308 that the indicated instruction was not to initiate customer billing or determined in block 368 that the received information is not indicative of customer preference information, the routine proceeds to block 390 to optionally perform any other actions as appropriate, such as any housekeeping tasks. In block 395, the routine then determines whether to continue, such as in response to an explicit indication to terminate. If it is to continue, the routine returns to block 304 to await additional instructions or information, and if not proceeds to step 399 and ends.

It will be appreciated that in some embodiments the functionality provided by the routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel, or synchronous or asynchronous) and/or in a particular order, in other embodiments the operations may be performed in other orders and in other manners. Any data structures discussed above may also be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Moreover, aspects and features of the various embodiments of the techniques, features, functionality and related methods described above can be combined to provide further embodiments. Accordingly, the invention is not limited except as by corresponding claims and the elements recited by those claims. In addition, while certain aspects of the invention may be presented in certain claim forms at certain times, the inventors contemplate the various aspects of the invention in any available claim form. For example, while only some aspects of the invention may be recited as being embodied in a computer-readable medium at particular times, other aspects may likewise be so embodied.

What is claimed is:

1. A system, comprising:
one or more hardware processors;
a mailing preparation device that is communicatively coupled to the one or more hardware processors;
one or more components that, when executed by at least one of the one or more hardware processors:
transmit first electronic control signals to the mailing preparation device to cause the mailing preparation device to generate a printed copy of a first billing statement for a customer of one or more vendors;
transmit second electronic control signals to the mailing preparation device to cause the mailing preparation device to prepare and forward to the customer an envelope that includes the printed copy of the first billing statement and a remittance mechanism for the customer's use in providing a monetary payment related to the first billing statement;
receive, based at least in part on the forwarded prepared envelope, an indication of at least one communication from the customer related to the first billing statement;
automatically determine, based at least in part on the at least one indicated communication, to provide future printed copies of additional billing statements to the customer without including a return envelope;
transmit third electronic control signals to the mailing preparation device to cause the mailing preparation device to generate a printed copy of a subsequent billing statement for the customer; and
transmit, based at least in part on the automatic determination, fourth electronic control signals to the mailing preparation device to cause the mailing preparation device to prepare and forward to the customer, without including a remittance mechanism, a subsequent envelope that includes the printed copy of the subsequent billing statement for the one or more vendors.

2. The system of claim 1 wherein the one or more components obtain one or more user billing preferences from a banking service associated with the user, and wherein the indicated at least one communication from the customer related to the first billing statement includes at least one of the obtained user billing preferences.

3. A computer-implemented method comprising:
initiating, by one or more configured computing systems, sending a first printed copy of a first billing statement for one or more vendors to a customer via a mailing service, the first printed copy including a return envelope that is provided for the customer's use in providing a monetary payment related to the first billing statement;
receiving, by the one or more configured computing systems and after sending the first printed copy, an indication of at least one communication from the customer related to the first billing statement;
automatically determining, by the one or more configured computing systems and based at least in part on the indicated communication, to send future printed copies of additional billing statements to the customer without including a return envelope; and
initiating, by the one or more configured computing systems and based at least in part on the automatic determining, sending a printed copy of a second billing statement to the customer without including a return envelope for the customer's use.

4. The computer-implemented method of claim 3 wherein the indicated communication is an electronic payment made by the customer without use of the provided return envelope, and wherein the determining to send the future printed copies without including a return envelope is based on the payment being an electronic payment.

5. The computer-implemented method of claim 3 wherein the indicated communication is one of multiple electronic payments to the one or more vendors made by the customer, and wherein the determining to send the future printed copies without including a return envelope is based on the multiple electronic payments satisfying one or more predetermined criteria.

6. The computer-implemented method of claim 5 wherein the one or more predetermined criteria include a predetermined quantity of electronic payments from the customer to the one or more vendors.

7. The computer-implemented method of claim 5 wherein the one or more predetermined criteria include a predetermined quantity of consecutive electronic payments from the customer to the one or more vendors.

8. The computer-implemented method of claim 3 wherein the provided return envelope indicates at least one option for the customer related to future billing statements, and wherein the indicated communication includes a selection by the customer of the at least one indicated option, the selected option specifying to omit return envelopes from future billing statements.

9. The computer-implemented method of claim 3 wherein the first billing statement indicates at least one option for the customer related to future billing statements, and wherein the indicated communication includes a selection of the at least one option by the customer, the selected option specifying to omit return envelopes from future printed copies of future billing statements.

10. The computer-implemented method of claim 3 wherein the indicated communication is an electronic payment made by the customer using a graphical user interface provided by at least one of the one or more vendors, and wherein the determining to send the future printed copies without including a return envelope is based at least in part on interaction of the customer with the provided graphical user interface.

11. The computer-implemented method of claim 10 wherein the provided graphical user interface includes at least one option for the customer related to future billing statements, and wherein the interaction of the customer includes a selection of an option specifying to omit return envelopes from future printed copies of future billing statements.

12. The computer-implemented method of claim 3, further comprising, based at least in part on the automatic determining, updating one or more local records associated with the customer.

13. The computer-implemented method of claim 3 further comprising, based at least in part on the automatic determining, updating a record associated with the customer that is stored remotely by at least one of the one or more vendors.

14. The computer-implemented method of claim 3 wherein the one or more configured computing systems are operated by a banking service of the customer, and wherein the initiating of the sending of the printed copy of the second billing statement includes providing an indication to at least one of the one or more vendors to omit the return envelope from future printed copies of billing statements for the customer.

15. The computer-implemented method of claim 14 wherein providing the indication to the at least one vendor includes providing the indication via a programmatic interface associated with one or more of the at least one vendor and the banking service.

16. The computer-implemented method of claim 3 wherein the one or more configured computing systems are operated by at least one of the one or more vendors.

17. A non-transitory computer-readable medium having contents that, when executed, configure a computing system to:
generate, by the configured computing system and with respect to each of one or more billing accounts of a user, electronic control signals that cause one or more mailing preparation devices to create a first printed copy of a first billing statement for the billing account;
generate, by the configured computing system and with respect to each of the one or more billing accounts, electronic control signals that cause the one or more mailing preparation devices to prepare and forward to the user an envelope that includes the printed copy of the first billing statement and a first type of remittance mechanism for use in obtaining a monetary payment from the user related to the first billing statement;
receive, by the configured computing system, an indication of at least one communication related to at least one of the one or more billing accounts of the user; and
for each of the at least one billing accounts,
determine, by the configured computing system and based at least in part on the indicated communication, to omit remittance mechanisms of the first type from future printed copies of future billing statements for the billing account;
generate, by the configured computing system, electronic control signals that cause the one or more mailing preparation devices to create a printed copy of a second billing statement for the billing account; and
transmit, by the configured computing system and based at least in part on the determination to omit remittance mechanisms of the first type, additional electronic control signals that cause the one or more mailing preparation devices to prepare and forward to the user a second envelope that includes the second printed copy of the second billing statement for the billing account, wherein the additional electronic control signals include an indication to omit any remittance mechanism of the first type.

18. The non-transitory computer-readable medium of claim 17 wherein the at least one indicated communication is an electronic payment made by the user to each of at least one vendor associated with the at least one billing accounts, and wherein the determination to omit remittance mechanisms of the first type is based on the electronic payment satisfying one or more predetermined criteria.

19. The non-transitory computer-readable medium of claim 17 wherein the at least one indicated communication is an electronic payment made by the user using a graphical user interface, and wherein the determination to omit remittance mechanisms of the first type is based at least in part on interaction of the user with the graphical user interface.

20. The non-transitory computer-readable medium of claim 17 wherein the first type of remittance mechanism is a return envelope, wherein the return envelope forwarded with the printed copy of the first billing statement indicates at least one option for the user related to future statements, and wherein the at least one communication indicates that the user has selected an option to omit return envelopes from the future statements.
